(19) United States
(12) Patent Application Publication
(10) Pub. No.: US 2025/0007233 A1
(43) Pub. Date: Jan. 2, 2025

(54) ASYMMETRIC COMBINER WITH OPTIMUM BRIGHTNESS

(71) Applicant: Lumentum Operations LLC, San Jose, CA (US)

(72) Inventors: Richard D. FAULHABER, San Carlos, CA (US); Martin H. MUENDEL, Oakland, CA (US); Gongwen ZHU, San Jose, CA (US)

(21) Appl. No.: 18/474,664

(22) Filed: Sep. 26, 2023

Related U.S. Application Data
(60) Provisional application No. 63/510,738, filed on Jun. 28, 2023.

(51) Int. Cl. H01S 3/094; G02B 6/02; G02B 6/04; H01S 3/0941

(52) U.S. Cl. CPC H01S 3/094053; G02B 6/02; G02B 6/04; H01S 3/094003; H01S 3/0941

(57) ABSTRACT

In some implementations, an optical system may comprise a plurality of pump sources, an output fiber, and a combiner that comprises an input end coupled to the plurality of pump sources and an output end coupled to the output fiber. In some implementations, the combiner comprises a plurality of pump fibers coupled to the plurality of pump sources, and one or more filler fibers that are made from a cladding material. In some implementations, a quantity of the plurality of pump fibers is associated with an asymmetric packing geometry, and the plurality of pump fibers and the one or more filler fibers have a symmetric packing geometry at the input end of the combiner and a circular cross-section at the output end of the combiner. In some implementations, the plurality of pump fibers and the one or more filler fibers each have a substantially circular cross-section.

### CROSS-REFERENCE TO RELATED APPLICATION

This patent application claims priority to U.S. Provisional Patent Application No. 63/510,738, filed on Jun. 28, 2023, and entitled “ASYMMETRIC COMBINER WITH OPTIMUM BRIGHTNESS.” The disclosure of the prior application is considered part of and is incorporated by reference into this patent application.

### TECHNICAL FIELD

The present disclosure relates generally to a pump combiner structure and to a pump combiner with one or more filler fibers to enable a symmetric and stable packing geometry.

### BACKGROUND

Pump combiners are critical components of high-power fiber lasers. A pump combiner is used to combine pump light and signal light to increase a power of the signal light. For example, “optically pumping” a medium generally refers to techniques that are used to inject light in order to electronically excite the medium or constituents of the medium into other (usually higher-lying) energy levels. In the context of lasers or laser amplifiers, the goal is to achieve a population inversion in the gain medium and thereby obtain optical amplification via stimulated emission for a range of optical frequencies. In many cases, pump combiners are arranged in a bundle configuration, which is spliced to another optical structure (e.g., a master oscillator power amplifier (MOPA) or single pass fiber laser structure) that is configured to deliver many hundreds of watts (W) or kilowatts (KW) of pump power. A bundle configuration can be achieved by arranging pump fibers into a particular close-packed configuration (e.g., a hexagonal close-packing configuration, or the like), and fusing and tapering individual pump fibers into a bundle of a target size.

### SUMMARY

In some implementations, a combiner includes: a plurality of pump fibers, wherein the plurality of pump fibers each comprise: a core; and a cladding that surrounds the core; and one or more filler fibers that are made from a cladding material, wherein the plurality of pump fibers and the one or more filler fibers each have a substantially circular cross-section, wherein a quantity of the plurality of pump fibers is associated with an asymmetric packing geometry, and wherein the plurality of pump fibers and the one or more filler fibers have a symmetric packing geometry at an input end of the combiner and a circular cross-section at an output end of the combiner.

In some implementations, an optical system includes: a plurality of pump sources; an output fiber; and a combiner that comprises an input end coupled to the plurality of pump sources and an output end coupled to the output fiber, wherein the combiner comprises: a plurality of pump fibers coupled to the plurality of pump sources, wherein the plurality of pump fibers each comprise: a core; and a cladding that surrounds the core; and one or more filler fibers that are made from a cladding material, wherein the plurality of pump fibers and the one or more filler fibers each have a substantially circular cross-section, wherein a quantity of the plurality of pump fibers corresponds to a quantity of the plurality of pump sources and is associated with an asymmetric packing geometry, and wherein the plurality of pump fibers and the one or more filler fibers have a symmetric packing geometry at the input end of the combiner and a circular cross-section at the output end of the combiner.

In some implementations, a combiner includes: a plurality of pump fibers, wherein the plurality of pump fibers each comprise: a core made from a first material having a first refractive index parameter; and a cladding that surrounds the core; and one or more filler fibers, disposed along an outer circumference of the combiner, that are made from a cladding material having a second refractive index parameter that is less than the first refractive index parameter, wherein the plurality of pump fibers and the one or more filler fibers each have a substantially circular cross-section, and wherein the plurality of pump fibers and the one or more filler fibers have a symmetric packing geometry at an input end of the combiner and a circular cross-section at an output end of the combiner.

### BRIEF DESCRIPTION OF THE DRAWINGS

FIGS. 1A-1D are diagrams illustrating examples related to a pump combiner.

FIGS. 2A-2C are diagrams illustrating one or more examples related to brightness degradation and/or decreased process stability that may occur in a combiner with a quantity of ports that may lead to a suboptimal packing.

FIGS. 3A-3B are diagrams illustrating one or more examples of an asymmetric combiner with an optimum brightness.

### DETAILED DESCRIPTION

The following detailed description of example implementations refers to the accompanying drawings. The same reference numbers in different drawings may identify the same or similar elements.

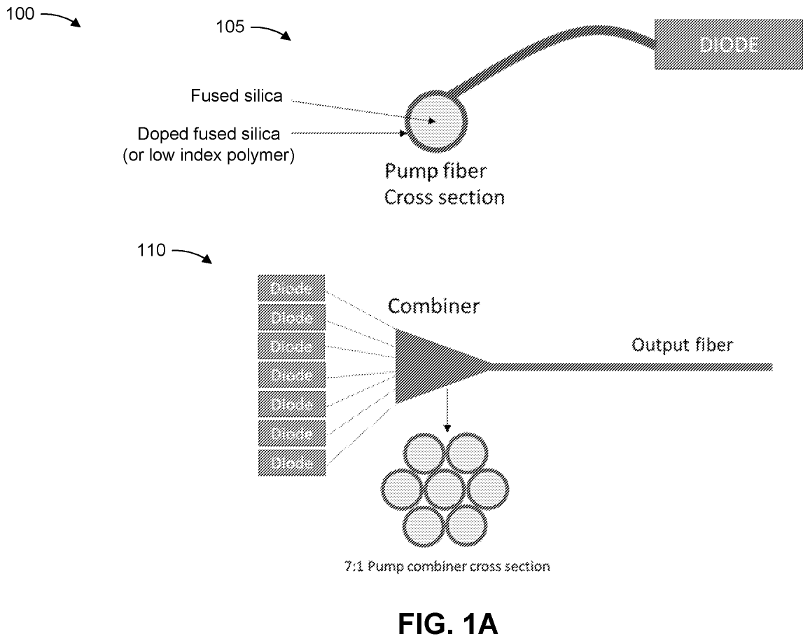

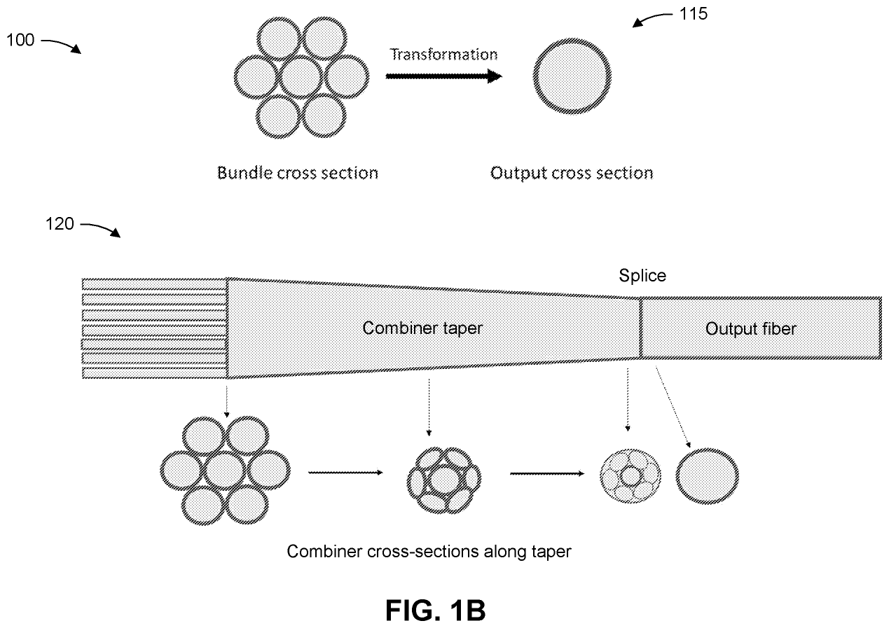

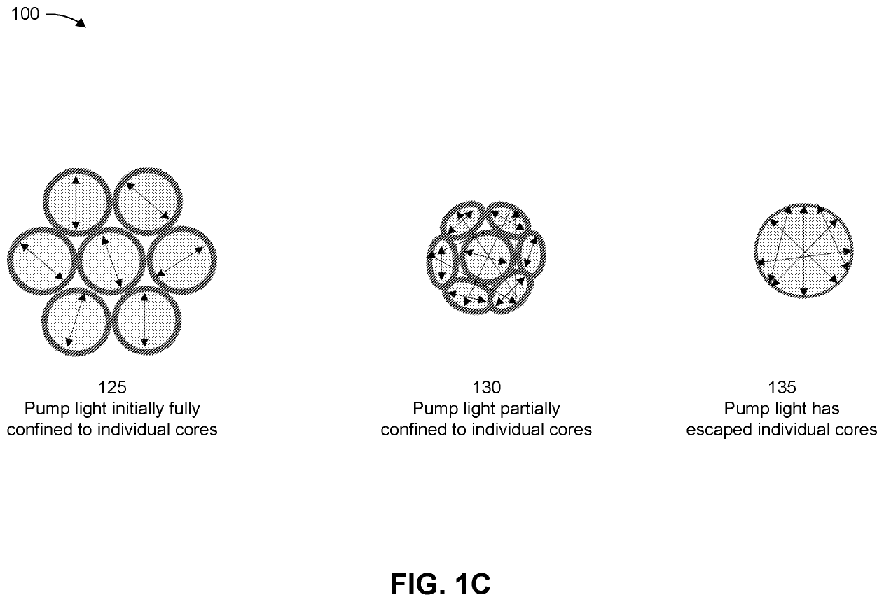

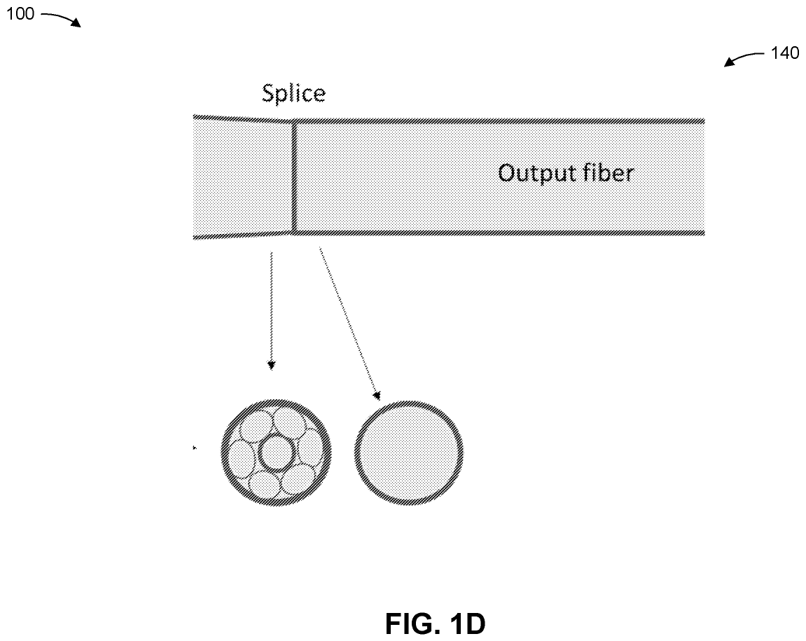

FIGS. 1A-1D are diagrams illustrating one or more examples 100 related to a pump combiner. For example, referring to FIG. 1A, reference number 105 refers to a pumping configuration, where a pump fiber is used to deliver pump light from a pump diode such that the pump light can be used to pump a fiber laser. As shown in FIG. 1A, the pump fiber may comprise a relatively large, fused silica core that is surrounded by a doped fused silica cladding, such as a fluorine-doped (F-doped) fused silica cladding. Additionally, or alternatively, the pump fiber used to deliver the pump light may be a polymer clad fiber, which includes a fused silica core surrounded by a low index polymer (e.g., rather than an F-doped glass cladding). The pump light in a pump configuration is typically contained within the fused silica core, and the brightness or beam parameter product (BPP) of the pump light may be approximated as the product of the numerical aperture (NA) and the radius (R) of the pump fiber (e.g., BPP=NA×R).

In some cases, as shown by reference number 110 in FIG. 1A, a pump combiner may be used to combine the power from several pumps in order to achieve the power that may be needed to pump a fiber laser. In particular, a pump combiner is a fiber component that fuses power from N pumps together and outputs the fused power from the N pumps into a single output fiber where the pump light can then be converted through by the fiber laser. Additionally, or alternatively, the output from the pump combiner can be used for a low-brightness laser source. For example, reference number 110 refers to a 7:1 pump combiner, which combines pump light from 7 diodes into a single output that is then delivered to an output fiber. For example, as shown by the cross-section, the pump combiner includes 7 fibers that are fused together and then spliced to the output fiber.

In cases where a pump combiner is used to combine the power from several pumps, brightness at the output of the pump combiner generally depends on the brightness of the pumps (e.g., the pump diodes) and the brightness degradation that occurs through combining the pumps into a single output fiber. In a perfect adiabatic combining condition, the brightness decreases (and the BPP increases) according to a square root of the quantity of ports in the combiner:

$${BPP}_{combiner} = \sqrt{\#ports} \times {BPP}_{diode}$$

where BPP_{combiner} refers to a BPP of light output by the combiner and BPP_{diode} refers to a BPP of light output by a diode.

Pump brightness is typically an important parameter to maintain (e.g., minimize an increase in) through a pump combiner for various reasons. For example, pump brightness influences the amount of pump light that has a high NA within the cladding of the fiber laser, where cladding light with a high NA can lead to more heating and lower reliability. Additionally, or alternatively, cladding light with a high NA can force a laser design to use a larger fiber, which can introduce processing problems and other issues. Furthermore, pump brightness can influence an absorption rate in an active fiber. For example, a higher NA can lead to more skew ray generation, which in turn decreases the absorption rate in the fiber core and causes a need for longer amounts of active fiber. For at least these reasons, pump combiners are typically required to operate near an adiabatic limit for brightness conversion.

In a simplest form, a combiner is generally used to transform multiple input fibers into a single output. Accordingly, an important design goal for a combiner is often to transform the multiple input fibers into a single output as efficiently as possible. For example, one approach to efficiently transform multiple input fibers into a single output is to pack the bundle of fibers being transformed together closely such that the shape of the bundle approaches a circle when the bundled fibers are fused and tapered, which leads to optimum splicing and minimal brightness degradation. For example, referring to FIG. 1B, reference number 115 refers to a case where 7 fibers are to be fused together to form a bundled cross-section that is circular or as close to circular as possible. For example, in some cases, the glass of each fiber in the bundle is heated, and tension is provided during a fusing process, which creates surface tension. The surface tension has an effect to minimize the surface area around the bundle, which begins to change the shape of the bundle from a hexagon-like shape into an optimum circle. As further shown by reference number 120 in FIG. 1B, the resulting structure is a pump combiner with a tapered shape. For example, as shown by the cross-sections of the combiner along the taper, an input end of the combiner includes various pump fibers that are matched (e.g., in location and area) to input fibers coupled to respective diodes. Near a middle region of the taper, the various pump fibers start to become more closely fused, reducing the space between the various fibers. At the output end of the combiner, the various pump fibers are closely packed and approximate a core of an output fiber that is spliced to the output end of the tapered combiner.

Furthermore, another important aspect of the process of combining multiple pump fibers into a single output is that the pump light traveling in the core increases in NA in a manner that is inversely proportional to the diameter of the fiber as the various fibers are being tapered (e.g., as the diameter of the fiber decreases, the NA generally increases). For example, pump fibers are typically associated with a 0.22 NA, in which case pump light with an NA that exceeds 0.22 will escape the core. As the pump light escapes the core and refracts into the cladding, the NA of the pump light decreases according to Snell's law, which states that, for a given pair of media, the ratio of the sines of the angle of incidence (θ₁) and the angle of refraction (θ₂) is equal to the refractive index of the second medium with respect to the first medium (n₂₁), which is equal to the ratio of the refractive indices (n₂/n₁) of the two media, or equivalently, to the ratio of the phase velocities (v₁/v₂) in the two media. For example, referring to FIG. 1C, reference number 125 refers to a state of the pump light at the input end of a 7:1 combiner, where the pump light is initially confined to the individual cores. However, as shown by reference number 130, which refers to a state of the pump light near the middle region of the 7:1 combiner, the pump light is only partially confined to the individual cores (e.g., some pump light has escaped the individual cores). Furthermore, as shown by reference number 135, which refers to a state of the pump light near the output end of the 7:1 combiner, the pump light has escaped the cores.

Referring to FIG. 1D, reference number 140 refers to a detailed view of the splice between the pump combiner and the output fiber. As shown, the combiner includes multiple fibers that are fused or pressed together with the pump light traversing through two distinct regions, which include a first region that corresponds to a set of fused silica cores and a second region that corresponds to claddings (e.g., F-doped fused silica or low index polymer claddings) surrounding the fused silica cores. Due to refraction, any light that occupies a particular cladding region will have a lower NA than light that occupies a core region. According to simulations, the probability of light occupying the core or the cladding may be impacted by various parameters, which may include a taper ratio, a taper length, and/or a fiber NA, among other examples. In addition, the probability of light occupying the core or the cladding may depend strongly on the area of the core or the cladding relative to the total area of the combiner. Consequently, as the amount of tapering that is performed is reduced and the core area increases, the probability of pump light being in the core increases. On the other hand, as the amount of tapering increases and the cladding area increases, the probability of pump light being in the cladding increases.

FIGS. 1A-1D are provided as examples. Other examples may differ from what is described with regard to FIGS. 1A-1D. The number and arrangement of devices shown in FIGS. 1A-1D are provided as examples. In practice, there may be additional devices, fewer devices, different devices, or differently arranged devices than those shown in FIGS. 1A-1D. Furthermore, two or more devices shown in FIGS. 1A-1D may be implemented within a single device, or a single device shown in FIGS. 1A-1D may be implemented as multiple, distributed devices. Additionally, or alternatively, a set of devices shown in FIGS. 1A-1D may perform one or more functions described as being performed by another set of devices shown in FIGS. 1A-1D.

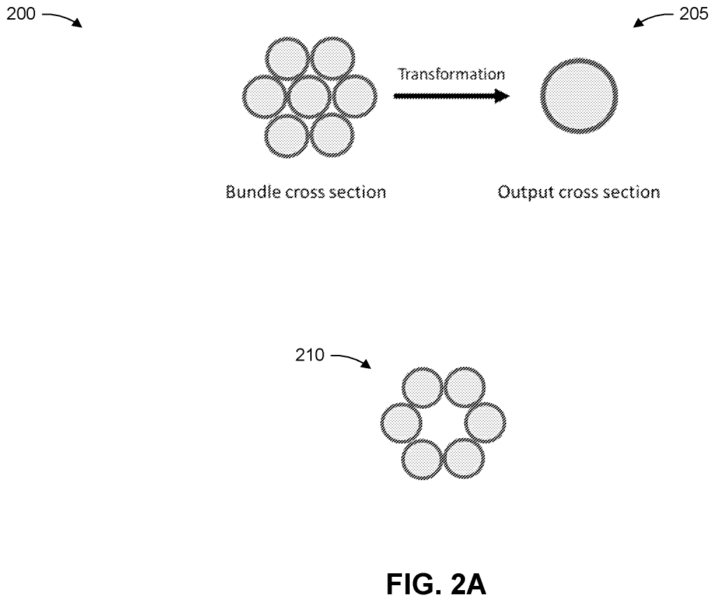

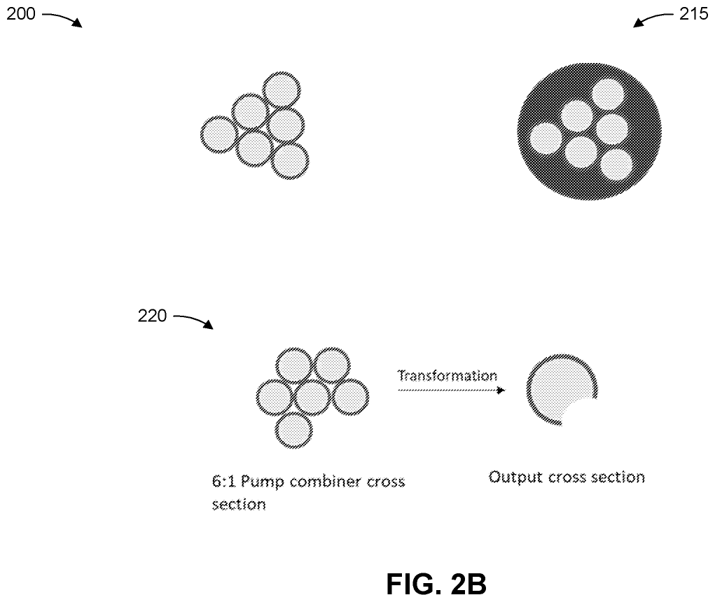

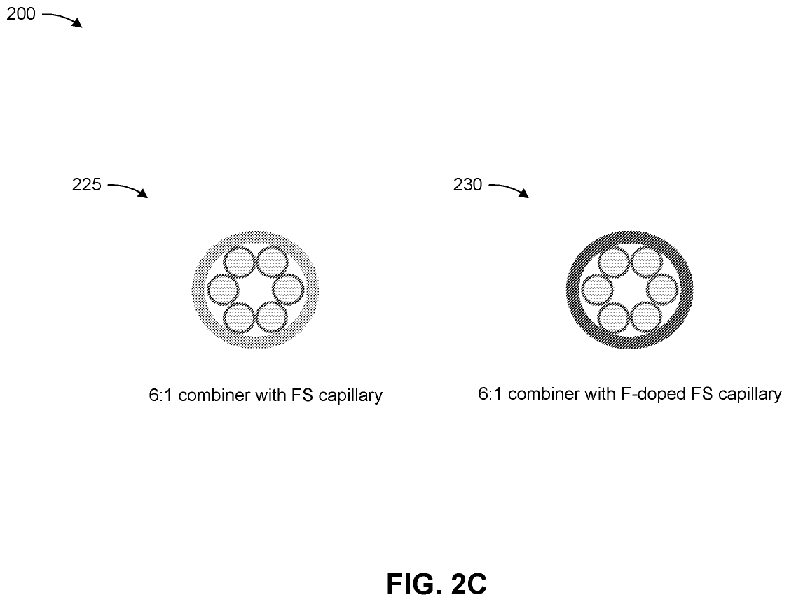

FIGS. 2A-2C are diagrams illustrating one or more examples 200 related to brightness degradation and/or decreased process stability that may occur in a combiner where the quantity of ports may lead to a suboptimal packing.

For example, referring to FIG. 2A, reference number 205 refers a typical 7:1 capillary-less combiner that has an optimum symmetry (e.g., 7 input fibers that form a hexagon-like shape at the input end of the combiner). In this case, the bundle is transformed from the hexagon-like shape to a circular or near-circular output cross section. However, in a scenario where only 6 ports are needed rather than 7 and a design goal is to optimize brightness, using a 7-port combiner would cause brightness to be discarded from the additional port even in cases where the additional port is not being used. Alternatively, reference number 210 refers to a combiner configuration with only 6 ports, which may be created by removing the center port in the bundle. However, the packing geometry shown by reference number 210 is unstable, and the fibers would be very difficult or impossible to keep together during the fusing and tapering process.

Accordingly, referring to FIG. 2B, reference number 215 refers to another possible approach, where the fiber is packed in a different geometry (e.g., a triangular shape) to stabilize the bundle fusing process. Although the bundle is stable in this case, the alternative geometry does not transform well into the circular or near-circular shape that is needed at the splice to the output fiber. For example, the shaded area between the fiber cores and the outer circular shape of the output fiber essentially represents the area where wasted brightness is occurring. Furthermore, removing one of the outer fibers from a bundle having a hexagon-like shape, as shown by reference number 220, would also result in a mismatch at the splice between the combiner and the output fiber, and therefore increased brightness degradation.

Referring to FIG. 2C, reference numbers 225 and 230 refer to an alternative approach to address the problem of degraded brightness and/or reduced bundle stability, where a capillary is used for the bundle process. However, using a capillary suffers from various drawbacks. For example, reference number 225 refers to an example where a fused silica capillary is used, which stabilizes the bundle for processing. However, the addition of fused silica causes the brightness of the output to be degraded (e.g., using fused silica is analogous to having more core area), possibly to a larger extent than using 7 fibers. Alternatively, reference number 230 refers to an example where F-doped fused silica is used, which is analogous to using more cladding area. Accordingly, if the combiner is tapered far enough and long enough, a brightness benefit may be observed. However, using a thin-walled F-doped capillary poses processing problems due to a much lower melting point, and the material is prone to bubbling during the tapering process and is therefore much more difficult to splice.

FIGS. 2A-2C are provided as examples. Other examples may differ from what is described with regard to FIGS. 2A-2C. The number and arrangement of devices shown in FIGS. 2A-2C are provided as examples. In practice, there may be additional devices, fewer devices, different devices, or differently arranged devices than those shown in FIGS. 2A-2C. Furthermore, two or more devices shown in FIGS. 2A-2C may be implemented within a single device, or a single device shown in FIGS. 2A-2C may be implemented as multiple, distributed devices. Additionally, or alternatively, a set of devices shown in FIGS. 2A-2C may perform one or more functions described as being performed by another set of devices shown in FIGS. 2A-2C.

Some implementations described herein relate to using a filler fiber to stabilize the packing and improve the brightness transformation in a combiner with an otherwise suboptimal packing geometry. For example, the filler fibers described herein generally have a dn that is less than a dn of the pump fiber core being used, where dn refers to a difference between the refractive index of a core and a refractive index of a cladding. For example, if the pump fiber core is standard fused silica, then the filler fiber can be a fluorosilicate glass, a borosilicate glass, or any other glass that has a dn that is less than the fused silica core. On the other hand, in cases where the core of the glass is germanium (Ge) doped fused silica, the filler fiber can be fused silica fiber or another suitable material. Furthermore, another important attribute of the filler fiber is that the filler fiber is not restricted to the geometry and size of the pump fibers, and can be of any geometry or size that stabilizes the bundle. The examples described herein illustrate a specific case with the use of standard fused silica pump fiber and a filler fiber that has the same material as the cladding of the pump fiber (e.g., F-doped fused silica or a low index polymer), but the filler fibers described herein may be doped with any suitable dopant with a dn that is less than the dn of fused silica, such as boron, fluorine, phosphorous and aluminum, or the like.

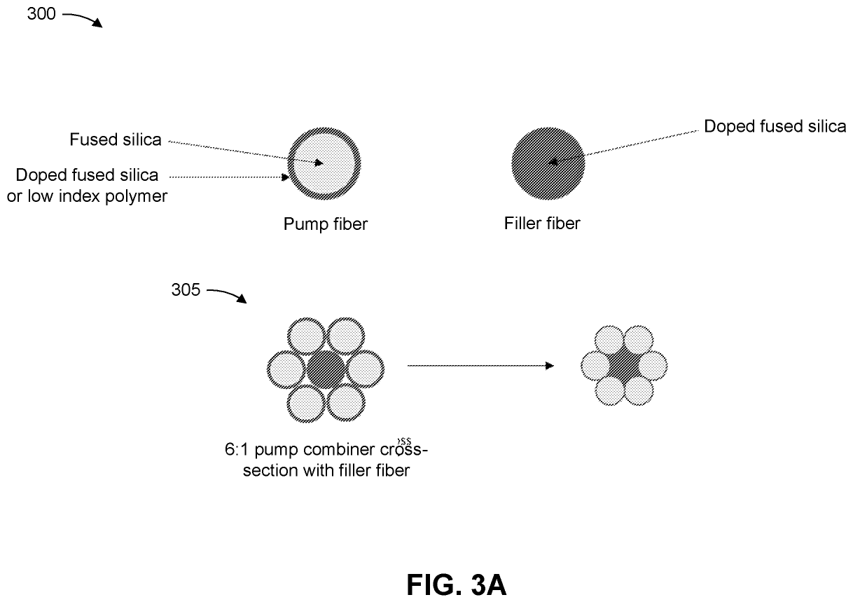

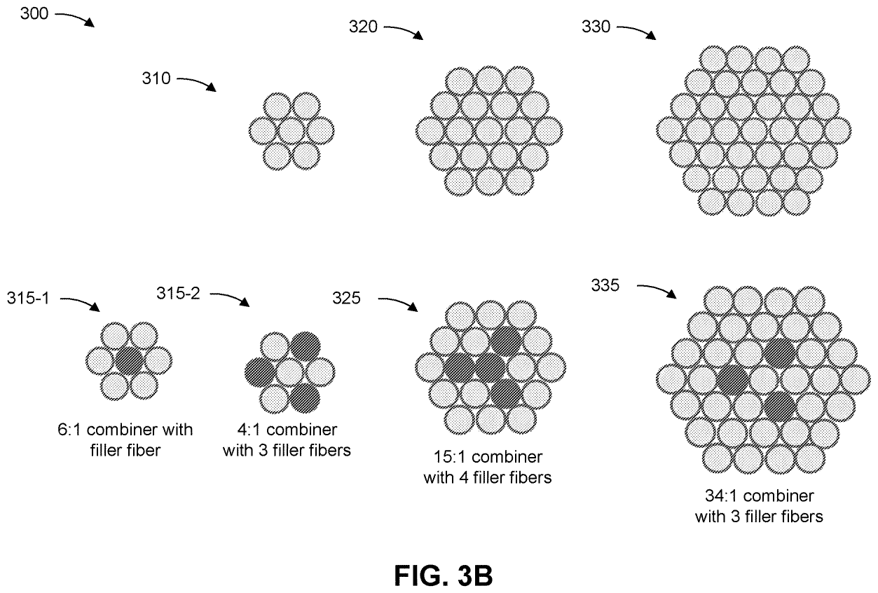

FIGS. 3A-3B are diagrams illustrating one or more examples 300 of an asymmetric combiner with an optimum brightness. For example, FIG. 3A illustrates a filler fiber that may be used in a combiner in cases where the number of ports in the combiner does not lead to a symmetric and stable packing geometry. In some implementations, the filler fiber may enable a stable combiner build process without sacrificing brightness of the combiner. Essentially, the filler fiber is a fiber that is made completely from fused silica that is doped with a suitable material or a low index polymer material such that the filler fiber has a dn that is less than a dn of the pump fiber core. For example, if the pump fiber core is standard fused silica, the filler fiber can be a fluorosilicate glass, a borosilicate glass, a low index polymer, or any glass that has a dn that is less than a dn of the fused silica core. In another example, in cases where the core of the glass is Ge-doped fused silica, the filler fiber can be fused silica fiber or another suitable material. Furthermore, another important attribute of the filler fiber is that the filler fiber is not restricted to the geometry and size of the pump fibers, and can be of any geometry or size that stabilizes the bundle. For example, as shown in FIG. 3A, the filler fiber may have an outer diameter equal to the outer diameter of the individual pump fibers.

Accordingly, as shown by reference number 305 in FIG. 3A, the filler fiber can enable a stable packing geometry to be used even in cases where the number of input ports differs from a number of input ports that results in a hexagon-like shape that normally produces a stable packing geometry. For example, reference number 305 refers to an example where the filler fiber is used at the center of a 6:1 combiner to produce a stable 7:1 packing geometry. Although FIG. 3A refers to an example where the filler fiber is used at the center of the combiner bundle, the filler fiber can replace any position of a pump fiber. In some implementations, adding the filler fiber to the otherwise asymmetric combiner bundle is analogous to adding more cladding material. Accordingly, the brightness benefit of the stable 7:1 packing geometry may be achieved as long as the bundle is tapered and light is squeezed out of the cores of the pump fibers. In addition, relative to techniques that use a capillary, using a filler fiber is less susceptible to bubbling because of the position of the filler fiber and relative heat exposure.

Furthermore, although FIG. 3A illustrates an example of a combiner based on a stable 7:1 packing geometry, filler fibers can be used in a combiner with any suitable quantity of ports. For example, the optimum packing geometries for capillary-less combiners with one center port are 7 ports, 19 ports, 37 ports, 61 ports, or the like. For example, referring to FIG. 3B, reference number 310 refers to an optimum packing geometry for a capillary-less combiner with one center port and 7 seven total ports, reference number 315-1 refers to a 6:1 combiner configuration with six pump fibers and a filler fiber used as the central fiber, and reference number 315-2 refers to a 4:1 combiner configuration with four pump fibers and three filler fibers located at various positions within the hexagonal packing geometry. In another example, reference number 320 refers to an optimum packing geometry for a capillary-less combiner with one center port and 19 total ports, and reference number 325 refers to a 15:1 combiner configuration with 15 pump fibers and 4 filler fibers located at various positions within the hexagonal packing geometry. In another example, reference number 330 refers to an optimum packing geometry for a capillary-less combiner with one center port and 37 total ports, and reference number 335 refers to a 34:1 combiner configuration with 34 pump fibers and 3 filler fibers located at various positions within the hexagonal packing geometry. In general, however, an optimum location for the filler fibers may be around the outer circumference of the combiner, because higher degradation generally occurs in the outer layers of the bundle configuration.

Accordingly, as described herein, a combiner with an optimum brightness may include multiple pump fibers that each comprise a core and a cladding that surrounds the core. In addition, in cases where a quantity of the plurality of pump fibers is associated with an asymmetric (e.g., non-hexagonal) packing geometry, the combiner may include one or more filler fibers that are made from a cladding material, such that the multiple pump fibers and the one or more filler fibers form a bundle, without a surrounding capillary structure, having a symmetric packing geometry at an input end of the combiner (e.g., a single center port and one or more hexagonal rings concentrically surrounding the single center port). Furthermore, the bundle has a circular cross-section at an output end of the combiner. In some implementations, an outer diameter of the one or more filler fibers equals an outer diameter of the pump fibers. Additionally, or alternatively, the one or more filler fibers may have a geometry and/or a size that differs from the pump fibers (e.g., the filler fiber is not restricted to the geometry and/or size of the pump fibers, and can have any geometry or size that stabilizes the fiber bundle). Furthermore, the core of each pump fibers is made from a first material having a first refractive index parameter (e.g., a first dn value), and the one or more filler fibers are made from a second material having a second refractive index parameter (e.g., a second dn value) that is less than the first refractive index parameter. In other words, the one or more filler fibers are made from any suitable material with a dn value that is less than a dn value of the pump fiber core being used. Additionally, or alternatively, the cladding of each pump fiber may be made from the cladding material used for the one or more filler fibers (e.g., F-doped fused silica or a low index polymer). Furthermore, the filler fibers may be located at any suitable position within the fiber bundle, although a location along an outer circumference of the combiner provides the lowest pump degradation because degradation is normally highest on the outer layers. Accordingly, as described herein, the combiner may be used in an optical system (e.g., a pumping system) that includes a plurality of pump sources (e.g., diodes) and an output fiber, with the combiner spliced or otherwise arranged between the pump sources and the output fiber. For example, in such cases, the quantity of pump fibers included in the bundle may generally correspond to the quantity of pump sources.

FIGS. 3A-3B are provided as examples. Other examples may differ from what is described with regard to FIGS. 3A-3B. The number and arrangement of devices shown in FIGS. 3A-3B are provided as examples. In practice, there may be additional devices, fewer devices, different devices, or differently arranged devices than those shown in FIGS. 3A-3B. Furthermore, two or more devices shown in FIGS. 3A-3B may be implemented within a single device, or a single device shown in FIGS. 3A-3B may be implemented as multiple, distributed devices. Additionally, or alternatively, a set of devices shown in FIGS. 3A-3B may perform one or more functions described as being performed by another set of devices shown in FIGS. 3A-3B.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “above,” “upper,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. A combiner, comprising:
a plurality of pump fibers, wherein the plurality of pump fibers each comprise:
a core; and
a cladding that surrounds the core; and
one or more filler fibers that are made from a cladding material,
wherein the plurality of pump fibers and the one or more filler fibers each have a substantially circular cross-section,
wherein a quantity of the plurality of pump fibers is associated with an asymmetric packing geometry, and
wherein the plurality of pump fibers and the one or more filler fibers have a symmetric packing geometry at an input end of the combiner and a circular cross-section at an output end of the combiner.

2. The combiner of claim 1, wherein an outer diameter of the one or more filler fibers equals an outer diameter of the plurality of pump fibers.

3. The combiner of claim 1, wherein the core of each of the plurality of pump fibers is made from a first material having a first refractive index parameter, and wherein the one or more filler fibers are made from a second material having a second refractive index parameter that is less than the first refractive index parameter.

4. The combiner of claim 1, wherein the one or more filler fibers are disposed along an outer circumference of the combiner.

5. The combiner of claim 1, wherein the cladding of each of the plurality of pump fibers is made from the cladding material used for the one or more filler fibers.

6. The combiner of claim 1, wherein the one or more filler fibers have one or more of a geometry or a size that differs from the plurality of pump fibers.

7. The combiner of claim 1, wherein the symmetric packing geometry comprises a single center port and one or more hexagonal rings concentrically surrounding the single center port.

8. The combiner of claim 1, wherein the plurality of pump fibers and the one or more filler fibers form a fiber bundle without a surrounding capillary.

9. An optical system, comprising:
a plurality of pump sources;
an output fiber; and
a combiner that comprises an input end coupled to the plurality of pump sources and an output end coupled to the output fiber, wherein the combiner comprises:
a plurality of pump fibers coupled to the plurality of pump sources, wherein the plurality of pump fibers each comprise:
a core; and
a cladding that surrounds the core; and
one or more filler fibers that are made from a cladding material,
wherein the plurality of pump fibers and the one or more filler fibers each have a substantially circular cross-section,
wherein a quantity of the plurality of pump fibers corresponds to a quantity of the plurality of pump sources and is associated with an asymmetric packing geometry, and
wherein the plurality of pump fibers and the one or more filler fibers have a symmetric packing geometry at the input end of the combiner and a circular cross-section at the output end of the combiner.

10. The optical system of claim 9, wherein an outer diameter of the one or more filler fibers equals an outer diameter of the plurality of pump fibers.

11. The optical system of claim 9, wherein the core of each of the plurality of pump fibers is made from a first material having a first refractive index parameter, and wherein the one or more filler fibers are made from a second material having a second refractive index parameter that is less than the first refractive index parameter.

12. The optical system of claim 9, wherein the one or more filler fibers are disposed along an outer circumference of the combiner.

13. The optical system of claim 9, wherein the cladding of each of the plurality of pump fibers is made from the cladding material used for the one or more filler fibers.

14. The optical system of claim 9, wherein the one or more filler fibers have one or more of a geometry or a size that differs from the plurality of pump fibers.

15. The optical system of claim 9, wherein the symmetric packing geometry comprises a single center port and one or more hexagonal rings concentrically surrounding the single center port.

16. The optical system of claim 9, wherein the plurality of pump fibers and the one or more filler fibers form a fiber bundle without a surrounding capillary.

17. A combiner, comprising:
a plurality of pump fibers, wherein the plurality of pump fibers each comprise:
a core made from a first material having a first refractive index parameter; and
a cladding that surrounds the core; and
one or more filler fibers, disposed along an outer circumference of the combiner, that are made from a cladding material having a second refractive index parameter that is less than the first refractive index parameter,
wherein the plurality of pump fibers and the one or more filler fibers each have a substantially circular cross-section, and
wherein the plurality of pump fibers and the one or more filler fibers have a symmetric packing geometry at an input end of the combiner and a circular cross-section at an output end of the combiner.

18. The combiner of claim 17, wherein the cladding of each of the plurality of pump fibers is made from the cladding material used for the one or more filler fibers.

19. The combiner of claim 17, wherein the symmetric packing geometry comprises a single center port and one or more hexagonal rings concentrically surrounding the single center port.

20. The combiner of claim 17, wherein the plurality of pump fibers and the one or more filler fibers form a fiber bundle without a surrounding capillary.
